(19) United States
(12) Patent Application Publication
(10) Pub. No.: US 2026/0368835 A1
(43) Pub. Date: Nov. 19, 2026

(54) SEARCH DEVICE, SEARCH SYSTEM, AND SEARCH METHOD

(71) Applicant: NEC Corporation, Tokyo (JP)

(72) Inventor: Haruki MIZUTANI, Tokyo (JP)

(73) Assignee: NEC Corporation, Tokyo (JP)

(21) Appl. No.: 19/655,963

(22) Filed: Apr. 23, 2026

(30) Foreign Application Priority Data
May 13, 2025 (JP) 2025-080803

(51) Int. Cl. G06Q 50/18; G06F 16/245; G06N 3/0475

(52) U.S. Cl. CPC G06Q 50/184; G06F 16/245; G06N 3/0475; G06F 2216/11

(57) ABSTRACT

Provided is a search device capable of efficiently searching for company information related to patent information. A search device includes an acquisition unit that acquires patent information, a generation unit that generates a business idea related to the patent information based on the acquired patent information, a search unit that searches, based on the generated business idea, for company information related to the business idea from a company database that stores company information including a business content of a company, and an output unit that outputs the generated business idea and the searched company information.

### INCORPORATION BY REFERENCE

This application is based upon and claims the benefit of priority from Japanese patent application No. 2025-080803, filed on May 13, 2025, the disclosure of which is incorporated herein in its entirety by reference.

### TECHNICAL FIELD

The present disclosure relates to a search device, a search system, a search method, and a program.

### BACKGROUND ART

For example, in an intellectual property department or a new business development department of a company, a business matching department of a financial institution, or the like, search for a company as a utilization destination is performed in order to promote the utilization of patents owned by the company. For example, JP 2020-52602 A is known as a related technique.

### SUMMARY

In order to search for a company as a patent utilization destination, a method of manually performing matching between patent information and company information is conceivable. However, there is a problem that efficiency is poor in a case where the search is manually performed, and for example, it takes time in a case where company information is enormous. In JP 2020-52602 A, although information for supporting research and development can be searched for from a database, company information related to patent information cannot be searched.

In view of such a problem, an example object of the present disclosure is to provide a search device, a search system, a search method, and a program capable of efficiently searching for company information related to patent information.

A search device according to an example aspect of the present disclosure includes acquisition means for acquiring patent information, generation means for generating a business idea related to the patent information based on the acquired patent information, search means for searching, based on the generated business idea, for company information related to a business idea from a company database that stores company information including a business content of a company, and output means for outputting the generated business idea and the searched company information.

A search system according to an example aspect of the present disclosure includes a company database that stores company information including a business content of a company, acquisition means for acquiring patent information, generation means for generating a business idea related to the patent information based on the acquired patent information, search means for searching for company information related to a business idea from the company database based on the generated business idea, and output means for outputting the generated business idea and the searched company information.

A search method according to an example aspect of the present disclosure is performed by a search device, and the search method includes acquiring patent information, generating a business idea related to the patent information based on the acquired patent information, searching, based on the generated business idea, for company information related to the business idea from a company database that stores company information including a business content of a company, and outputting the generated business idea and the searched company information.

A program according to an example aspect of the present disclosure is a program for causing a computer to execute processing including acquiring patent information, generating a business idea related to the patent information based on the acquired patent information, searching, based on the generated business idea, for company information related to the business idea from a company database that stores company information including a business content of a company, and outputting the generated business idea and the searched company information.

According to the present disclosure, it is possible to efficiently search for company information related to patent information.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a configuration diagram illustrating a configuration example of a search device according to some example embodiments;

FIG. 2 is a configuration diagram illustrating a configuration example of a search system according to some example embodiments;

FIG. 3 is a flowchart illustrating an example of a search method according to some example embodiments;

FIG. 4 is a configuration diagram illustrating a configuration example of a search system according to some example embodiments;

FIG. 5 is a diagram illustrating an example of data of a patent database according to some example embodiments;

FIG. 6 is a diagram illustrating an example of data of a company database according to some example embodiments;

FIG. 7 is a flowchart illustrating an operation example of the search system according to some example embodiments;

FIG. 8 is a diagram illustrating an example of a prompt to be input to generative AI according to some example embodiments;

FIG. 9 is a diagram illustrating an example of output of generative AI according to some example embodiments;

FIG. 10 is a diagram illustrating an example of output of generative AI according to some example embodiments;

FIG. 11A is a diagram illustrating an example of output of generative AI according to some example embodiments;

FIG. 11B is a diagram illustrating an example of output of generative AI according to some example embodiments;

FIG. 11C is a diagram illustrating an example of output of generative AI according to some example embodiments;

FIG. 12 is a diagram illustrating an example of a prompt to be input to generative AI according to some example embodiments;

FIG. 13A is a diagram illustrating an example of output of generative AI according to some example embodiments;

FIG. 13B is a diagram illustrating an example of output of generative AI according to some example embodiments;

FIG. 13C is a diagram illustrating an example of output of generative AI according to some example embodiments;

FIG. 14 is a diagram illustrating an example of output of a search result of the search system according to some example embodiments;

FIG. 15 is a diagram illustrating an example of output of a search result of the search system according to some example embodiments;

FIG. 16 is a configuration diagram illustrating a configuration example of a search system according to some example embodiments;

FIG. 17 is a flowchart illustrating an operation example of the search system according to some example embodiments;

FIG. 18 is a diagram illustrating an example of a prompt to be input to generative AI according to some example embodiments;

FIG. 19 is a diagram illustrating an example of output of generative AI according to some example embodiments;

FIG. 20A is a diagram illustrating an example of output of generative AI according to some example embodiments;

FIG. 20B is a diagram illustrating an example of output of generative AI according to some example embodiments;

FIG. 20C is a diagram illustrating an example of output of generative AI according to some example embodiments;

FIG. 21 is a configuration diagram illustrating a configuration example of a search system according to some example embodiments;

FIG. 22 is a configuration diagram illustrating a configuration example of a search system according to some example embodiments;

FIG. 23 is a diagram illustrating an example of data of a university/research institution database according to some example embodiments;

FIG. 24 is a flowchart illustrating an operation example of the search system according to some example embodiments; and

FIG. 25 is a configuration diagram illustrating a configuration example of hardware of a computer according to some example embodiments.

### EXAMPLE EMBODIMENTS

Hereinafter, example embodiments will be described with reference to the drawings. In the drawings, the same elements are denoted by the same reference signs, and redundant description will be omitted as necessary.

### First Example Embodiment

A first example embodiment will be described. In the present example embodiment, outlines of some example embodiments will be described.

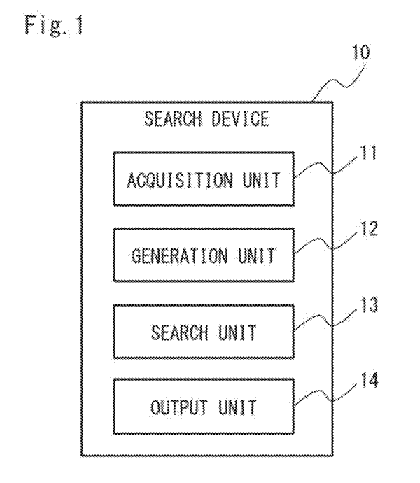

FIG. 1 illustrates a configuration example of a search device 10 according to some example embodiments. For example, the search device 10 is a device that searches for a related company that is a company as a patent utilization destination. In the example of FIG. 1, the search device 10 includes an acquisition unit 11, a generation unit 12, a search unit 13, and an output unit 14.

The acquisition unit 11 acquires patent information regarding the patent as a search target. For example, the acquisition unit 11 may acquire patent information regarding the patent designated by a user from a patent database. The target patent may be registered or be in a state before registration. For example, patent information may include all pieces or any information regarding a patent, such as a number specifying the target patent (application number, publication number, and patent number, and the like), a title of the invention, an abstract, claims, description, and the like.

The generation unit 12 generates a business idea related to patent information based on the patent information acquired by the acquisition unit 11. The business idea is an idea for commercializing the target patent. For example, the business idea may include a specific implementation method of a product or a service, an application field, and the like, which are derived from patent information.

The generation unit 12 may generate a business idea by using a learning model obtained by performing machine learning of a relation between patent information and a business idea. The generation unit 12 may generate a business idea by using generative AI (generative artificial intelligence) as an example of the learning model. For example, the generation unit 12 may input a first prompt for an instruction to output a business idea related to patent information to first generative AI, and generate the business idea by the first generative AI. The first prompt may include an instruction to select a business category related to the patent information, and output a business idea in the selected business category.

Based on the business idea generated by the generation unit 12, the search unit 13 searches for company information related to the business idea from a company database that stores company information including a business content of a company. The search unit 13 may calculate a relevance degree between the business idea and the business content of the company information, and search for the company information related to the business idea based on the calculated relevance degree.

The search unit 13 may search for the company information by using the generative AI as an example of the learning model. For example, the search unit 13 may input a second prompt for an instruction to output company information related to a business idea from the company database to second generative AI capable of retrieval augmented generation (RAG) and search for company information by the second generative AI. The second prompt may include an instruction to output searched company information, an evaluation of the searched company information, and a reason for the evaluation.

The search unit 13 may generate a business model constructed by a company of the searched company information. For example, the search unit 13 may input a third prompt for an instruction to output the business model constructed by the company of the searched company information to third generative AI based on the business idea, and generate the business model by the third generative AI.

The search unit 13 may search for company information related to a business idea based on a management index or the like of a company. The management index may include numerical data indicating a management state such as a financial condition, a growth rate, and a research and development investment ratio of a company. The search unit 13 may search for university or research institution information related to patent information or a business idea from a university or research institution database that stores university or research institution information including a research content of a university or research institution.

The output unit 14 outputs the business idea generated by the generation unit 12 and the company information searched by the search unit 13. The output unit 14 may output either the business idea or the company information. The output unit 14 may output a relevance degree between the generated business idea and the business content of the searched company information. The relevance degree may be a numerical value of technical and business compatibility between a business idea and a company (matching rate or the like).

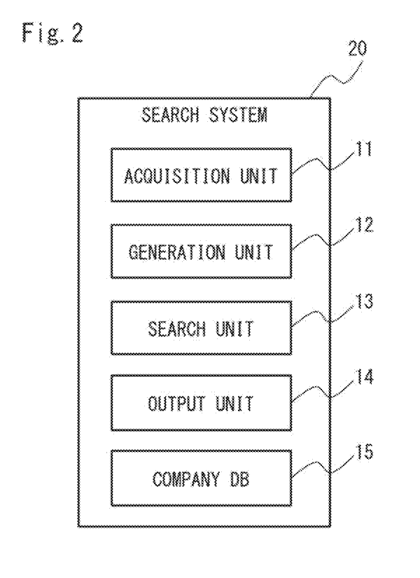

Each unit in the search device 10 may be included in one device or a plurality of devices, or may be included in a search system including one device or a plurality of devices. FIG. 2 illustrates a configuration example of a search system 20 according to some example embodiments. In the example of FIG. 2, the search system 20 includes an acquisition unit 11, a generation unit 12, a search unit 13, an output unit 14, and a company database (DB) 15. For example, the acquisition unit 11, the generation unit 12, the search unit 13, the output unit 14, and the company database 15 may be distributed and arranged in a plurality of devices.

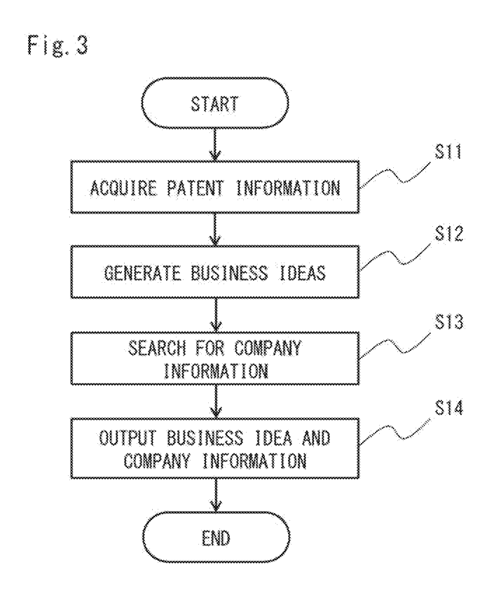

FIG. 3 illustrates an example of a search method according to some example embodiments. For example, the search method according to some example embodiments is executed by the search device 10 in FIG. 1 or the search system 20 in FIG. 2.

In the example of FIG. 3, the acquisition unit 11 acquires patent information (S11). For example, the acquisition unit 11 searches a patent database and acquires patent information regarding a patent designated by a user.

Then, the generation unit 12 generates a business idea related to patent information based on the patent information (S12). For example, the generation unit 12 inputs a predetermined prompt to generative AI, and generates a business idea related to the patent information by the generative AI.

Then, based on the generated business idea, the search unit 13 searches for company information related to the business idea from the company database 15 that stores company information including a business content of a company (S13). For example, the search unit 13 inputs a predetermined prompt to the generative AI capable of retrieval augmented generation, and searches for company information related to the business idea from the company database by the generative AI.

Then, the output unit 14 outputs the generated business idea and the searched company information (S14). The output unit 14 calculates a relevance degree between the generated business idea and the business content of the searched company information, and outputs the calculated relevance degree.

As described above, in the present example embodiment, a business idea is generated based on patent information, and company information is searched for based on the business idea. As a result, it is possible to efficiently search for company information of an appropriate company that can utilize patent information. For example, by utilizing the generative AI, it is possible to reliably generate a business idea for utilizing patent information.

### Second Example Embodiment

Next, a second example embodiment will be described. In the present example embodiment, a specific example of the first example embodiment will be described.

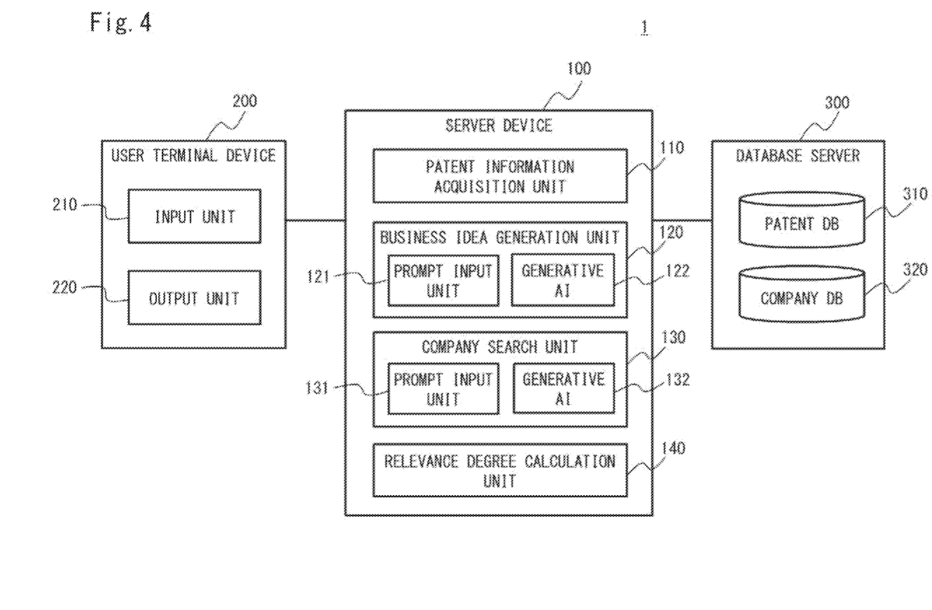

FIG. 4 illustrates a configuration example of a search system 1 according to some example embodiments. For example, the search system 1 is a system that efficiently searches for related companies and technologies by using patent information as an input. The search system 1 enables an intellectual property department, a new business development department, a business matching department of a financial institution, and the like to automate and improve efficiency in search for a partner for business transaction or open innovation starting from patent information.

In the example of FIG. 4, the search system 1 includes a server device 100, a user terminal device 200, and a database server 300. The server device 100 may be connected to the user terminal device 200 and the database server 300 via an input/output interface to be capable of input and output, or may be communicatively connected to the user terminal device 200 and the database server 300 via a network.

The configuration of the search system 1 in FIG. 4 is an example, and other configurations may be used as long as an operation (method) according to some example embodiments can be executed. The server device 100, the user terminal device 200, and the database server 300 may have other functions or may omit some functions as necessary. Each function of the server device 100, the user terminal device 200, and the database server 300 may be achieved by one device or any number of devices. For example, the server device 100 may include some or all of the functions of the user terminal device 200 or the database server 300. The user terminal device 200 may include some or all of the functions of the server device 100 or the database server 300.

The user terminal device 200 is a terminal device used by a user for input/output operations. For example, the user terminal device 200 may be any type of computer device such as a personal computer or a tablet terminal.

The user terminal device 200 includes an input unit 210 and an output unit 220. The input unit 210 is an input device for the user to input information and the like necessary for company search processing in the server device 100. For example, the input unit 210 may be a keyboard, a mouse, a touch panel, or the like. The input unit 210 may include a user interface such as a graphical user interface (GUI). The input unit 210 receives input information input by the user. For example, the user inputs a patent identification number that enables identifying of a patent, and the input unit 210 receives the input patent identification number. The input patent identification number may be any of an application number, a publication number, and a patent number. The input unit 210 transmits the input patent identification number to a patent information acquisition unit 110 of the server device 100. Although an example of inputting one patent identification number will be described, a plurality of patent identification numbers may be input and companies related to a plurality of pieces of patent information may be searched for.

The output unit 220 is an output device that outputs a result of the company search processing in the server device 100 and the like to the user. For example, the output unit 220 may be a display device such as a liquid crystal display or an organic electro-luminescence (EL) display. Similarly to the input unit 210, the output unit 220 may include a user interface such as a GUI. For example, the output unit 220 receives the result of the company search processing from a relevance degree calculation unit 140 of the server device 100, and displays the received processing result on a display screen of the GUI. The output unit 220 may output the result of the company search processing or the like by any output method including voice or the like without being limited to display.

The database server 300 is a data storage device that stores data necessary for the company search processing and the like in the server device 100. The database server 300 may be a single database device or a distributed database including a plurality of database devices. The database server 300 may be one or a plurality of physical servers (physical machines), or may be a virtualized server (virtual machine) constructed on a virtualization platform such as a cloud.

The database server 300 includes a patent database (DB) 310 and a company database (DB) 320. The database server 300 may include other databases as necessary. The patent database 310 is a database that stores patent information. For example, the patent database 310 stores patent information including a patent identification number, and can search patent information from the patent identification number.

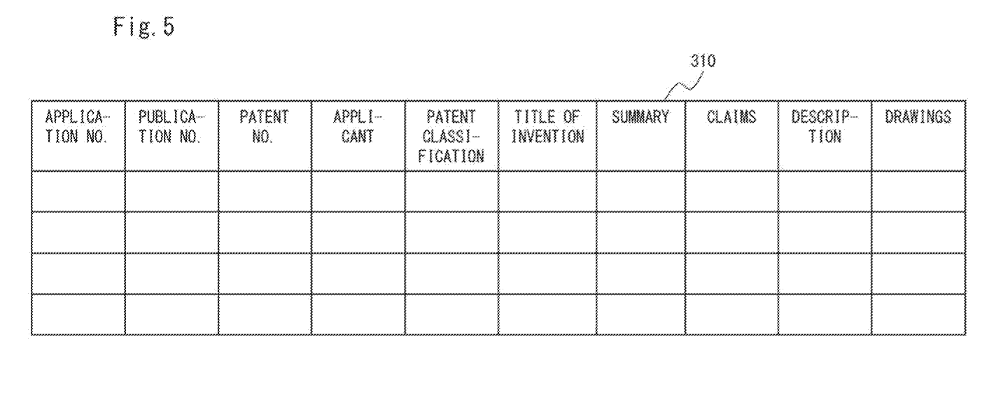

FIG. 5 is a diagram illustrating an example of data of the patent database 310 according to some example embodiments. In the example of FIG. 5, the patent database 310 stores, for each patent, an application number, a publication number, a patent number (registration number), an applicant, a patent classification, a name of an invention, an abstract, claims, a description, and a drawing. For example, the patent identification number includes an application number, a publication number, and a patent number. In a case where the patent information can be specified, the patent identification number may be any other type of information (internal number or the like). The claims may be registered claims or claims before being registered. As long as a business idea can be generated or a related company can be searched for, the patent information may be any one of these types of information. The patent information may include other types of information such as an inventor, an application date, a publication date, a registration date, examination progress information (examination results, dispatched documents, submitted documents, and the like), and family application information.

The company database 320 is a database that stores company information. For example, the company database 320 stores company information including a business content of a company, and can search for the company information from the business content.

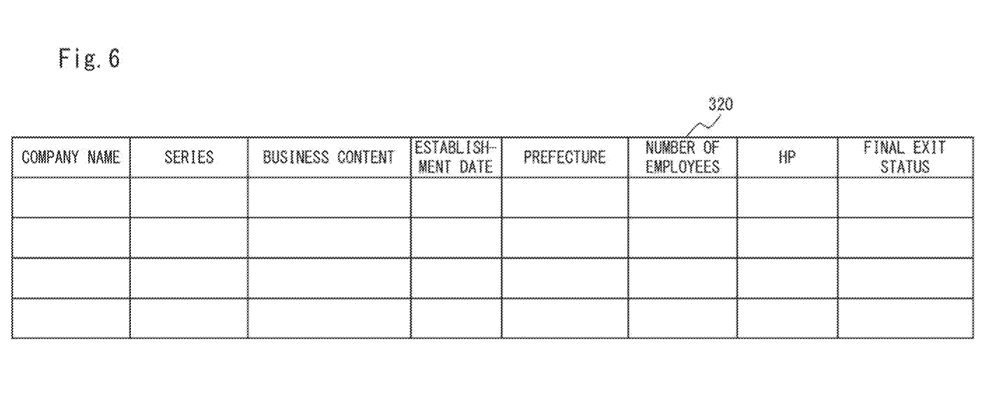

FIG. 6 illustrates an example of data in the company database 320 according to some example embodiments. In the example of FIG. 6, the company database 320 stores, for each company, a company name, a series (investment round), a business content, an establishment date, a prefecture (location), the number of employees, HP (home page), and a final EXIT status. The company information may be any of these types of information as long as the company can be specified from the business content. The company information may include other types of information such as capital, sales, and representative.

The server device 100 is a search device that executes the company search processing of searching for a related company as a patent utilization destination based on the patent information. The server device 100 may be a dedicated server device or any type of computer device including a general-purpose server computer. The server device 100 may be one or a plurality of physical servers (physical machines), or may be a virtualized server (virtual machine) constructed on a virtualization platform such as a cloud. For example, the server device 100 and the database server 300 may be the same physical machine or the same virtual machine.

The server device 100 includes the patent information acquisition unit 110, a business idea generation unit 120, a company search unit 130, and the relevance degree calculation unit 140.

The patent information acquisition unit 110 searches for and acquires patent information based on the patent identification number. The patent information acquisition unit 110 receives the patent identification number input by the user from the input unit 210 of the user terminal device 200, and searches the patent database 310 for patent information associated with the received patent identification number. The patent information acquisition unit 110 outputs the patent information acquired by the search to the business idea generation unit 120. The patent information acquisition unit 110 may acquire all pieces of information included in the corresponding patent information, or may acquire information necessary for generating a business idea.

The business idea generation unit 120 generates a business idea based on the patent information. The business idea generation unit 120 generates a business idea for commercializing the patent indicated by the patent information acquired by the patent information acquisition unit 110, and outputs the generated business idea to the company search unit 130.

The business idea generation unit 120 includes a prompt input unit 121 and generative AI 122. The prompt input unit 121 inputs a prompt (for example, a first prompt) including an instruction for generating a business idea based on the patent information to the generative AI 122 (for example, first generative AI). For example, the prompt to be input to the generative AI 122 may be set in advance, or the user may input information necessary for the prompt. The prompt input unit 121 may input information selected from the patent information to the generative AI 122. For example, at least the claims and the description may be input. In a case where the generative AI 122 can analyze the drawing, the drawing may be input. The information to be input in the patent information may be selected by the user or may be set in advance. The prompt input unit 121 may change the prompt according to the information to be input.

The generative AI 122 generates the business idea based on the patent information in accordance with the input prompt. The generative AI 122 may generate a plurality of business ideas based on the patent information. For example, the generative AI 122 is a large language model (LLM). The LLM is a language model trained using enormous amount of text data. The LLM can perform inference by natural language processing (NLP) and generate a sentence or the like according to a given prompt. The LLM may learn a language corpus for learning, Web data, data in a specific field (including books, papers, and the like), and the like. If necessary, the LLM may learn data (including description and the like) in a field related to a patent, data in a field related to a technique to which a patent is applied or a business, and the like. The generative AI 122 may be an LLM in which general-purpose data has been learned or may be an LLM fine-tuned in such a way as to generate an appropriate business idea from patent information. For example, the LLM is a transformer-based language model, and may be a GPT (Generative Pretrained Transformer) such as GPT-3 or GPT-4, BERT (Bidirectional Encoder Representations from Transformers), LaMDA (Language Model for Dialogue Applications), PaLM (Scaling Language Modeling with Pathways), LlaMA (Large Language Model Meta AI), or the like. The LLM is not limited to Transformer, and may be a language model based on other neural networks such as a convolutional neural network (CNN), a recurrent neural network (RNN), or a long short term memory (LSTM).

The company search unit 130 searches for a related company related to the business idea. Based on the business idea generated by the business idea generation unit 120, the company search unit 130 searches the company database 320 for company information of a related company capable of realizing the business of the business idea. For example, company information including a business content that has a high relevance degree to the business idea may be searched for. The company search unit 130 outputs the company information acquired by the search to the relevance degree calculation unit 140.

The company search unit 130 includes a prompt input unit 131 and generative AI 132. The prompt input unit 131 inputs, to the generative AI 132 (for example, second generative AI), a prompt (for example, second prompt) including an instruction for searching for company information related to the business idea from the company database 320. For example, the prompt to be input to the generative AI 132 may be set in advance, or the user may input information necessary for the prompt.

The generative AI 132 searches for the company information related to the business idea from the company database 320 in accordance with the input prompt. In a case where a plurality of business ideas are generated, the generative AI 132 may search for companies related to all business ideas, or may search for companies related to some of the business ideas. For example, the generative AI 132 is an LLM similarly to the generative AI 122. The generative AI 132 may be an LLM augmented by Retrieval Augmented Generation (RAG). By using the RAG, the company information can be searched from data of the company database 320 that the LLM has not learned, and the search result can be output.

The relevance degree calculation unit 140 calculates the relevance degree between the business idea and the company information. The relevance degree calculation unit 140 calculates the relevance degree between the business idea generated by the business idea generation unit 120 and the business content of the company information searched by the company search unit 130. For example, the relevance degree is a matching rate between the business idea and the business content of the company information. That is, the relevance degree is a matching rate (similarity) between a sentence or a word indicating the business idea and a sentence or a word indicating the business content of the company information. The relevance degree may be calculated by including not only the business content of the company information but also other types of information. The relevance degree calculation unit 140 transmits the generated business idea, the searched company information, and the calculated relevance degree to the output unit 220 of the user terminal device 200. For example, in a case where pieces of company information of a plurality of related companies are searched for, company information having a relevance degree higher than a predetermined value may be transmitted to the output unit 220.

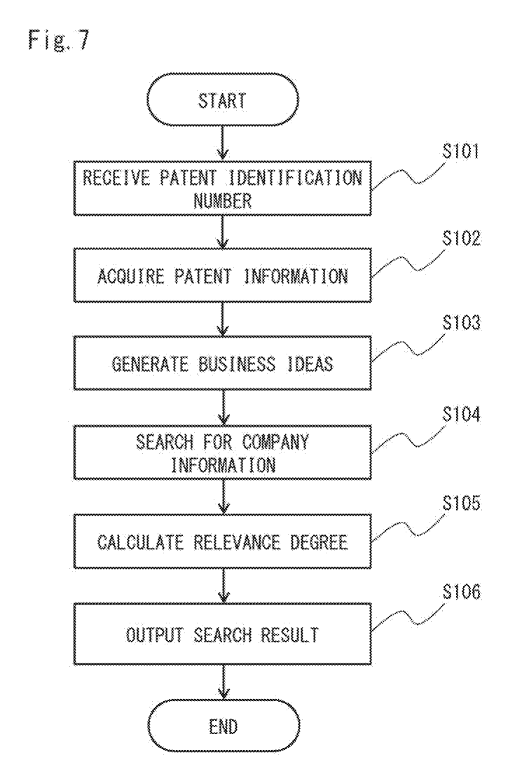

FIG. 7 illustrates an operation example of the search system 1 according to some example embodiments. In the example of FIG. 7, the input unit 210 receives a patent identification number (S101). For example, the user inputs a patent identification number of a patent for searching for a related company, and the input unit 210 receives the input patent identification number. For example, the input unit 210 receives a patent number as the patent identification number, and transmits the received patent number to the patent information acquisition unit 110.

Subsequently, the patent information acquisition unit 110 acquires patent information based on the received patent identification number (S102). For example, the patent information acquisition unit 110 searches the patent database 310 by using the patent number input by the user as a search key, and acquires patent information including the corresponding patent number. For example, the patent information acquisition unit 110 acquires claims and a description associated with the patent number.

Subsequently, the business idea generation unit 120 generates a business idea based on the acquired patent information (S103). For example, the prompt input unit 121 inputs, to the generative AI 122, the acquired patent information and a prompt P10 for an instruction to generate a business idea based on the patent information.

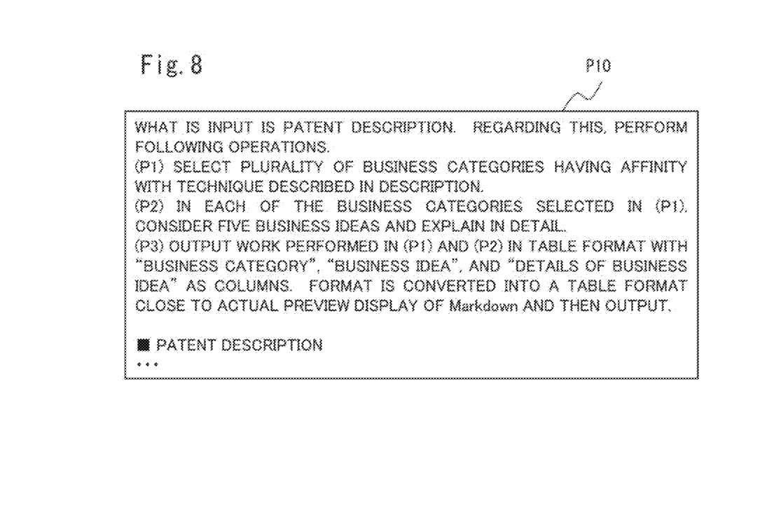

FIG. 8 illustrates an example of the prompt P10 to be input to the generative AI 122 according to some example embodiments. In the example of FIG. 8, the prompt P10 includes instructions P1 to P3 and patent information. The patent information may be, for example, the entire contents of the claims and the description. The instruction P1 is an instruction for selecting a business category that has affinity with (is related to) patent information such as the description. For example, the instruction P1 may designate the number of business categories to be selected. The instruction P2 is an instruction for generating and explaining a business idea in the business category selected in the instruction P1. As an example, the instruction P2 instructs to generate five business ideas for each business category. The instruction P3 is an instruction for outputting results of the instructions P1 and P2 in a table format having “business category”, “business idea”, and “details of business idea” as columns. The number of business ideas to be generated and an output format of the business ideas may be set in advance or may be selected by the user.

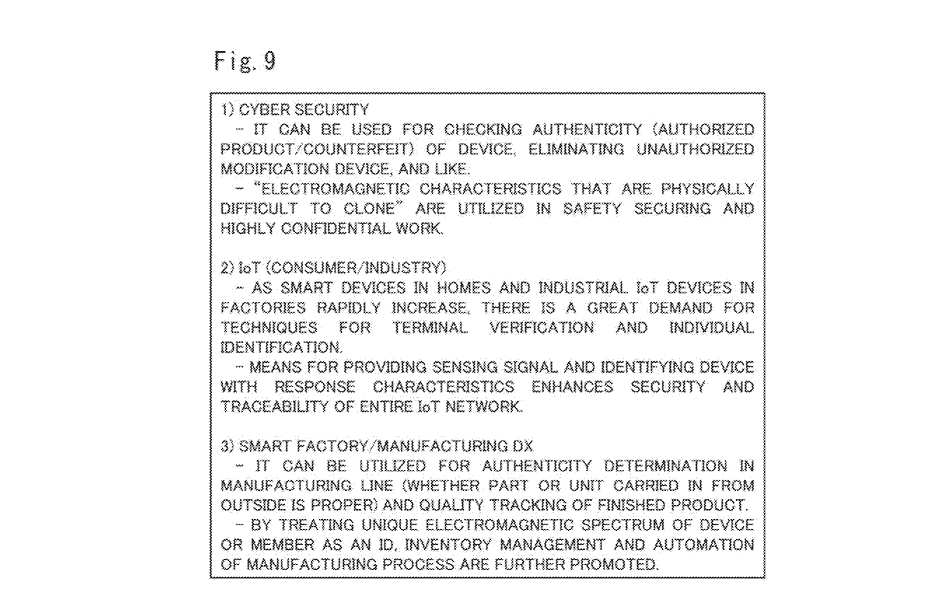

The generative AI 122 outputs the results for the instructions P1 to P3 in accordance with the input prompt P10. FIGS. 9, 10, and 11A to 11C are output examples of the generative AI 122. As an example, it is an output example regarding “technique for performing authenticity determination and individual identification by using electromagnetic characteristics unique to a device” described in the acquired description (individual determination device and method of target device). FIG. 9 illustrates an output example of the generative AI 122 with respect to the instruction P1 (business category having affinity with the present technique). In the example of FIG. 9, three business categories related to the patent information are selected in accordance with the instruction P1, and the selected three business categories and the explanation of each business category are output.

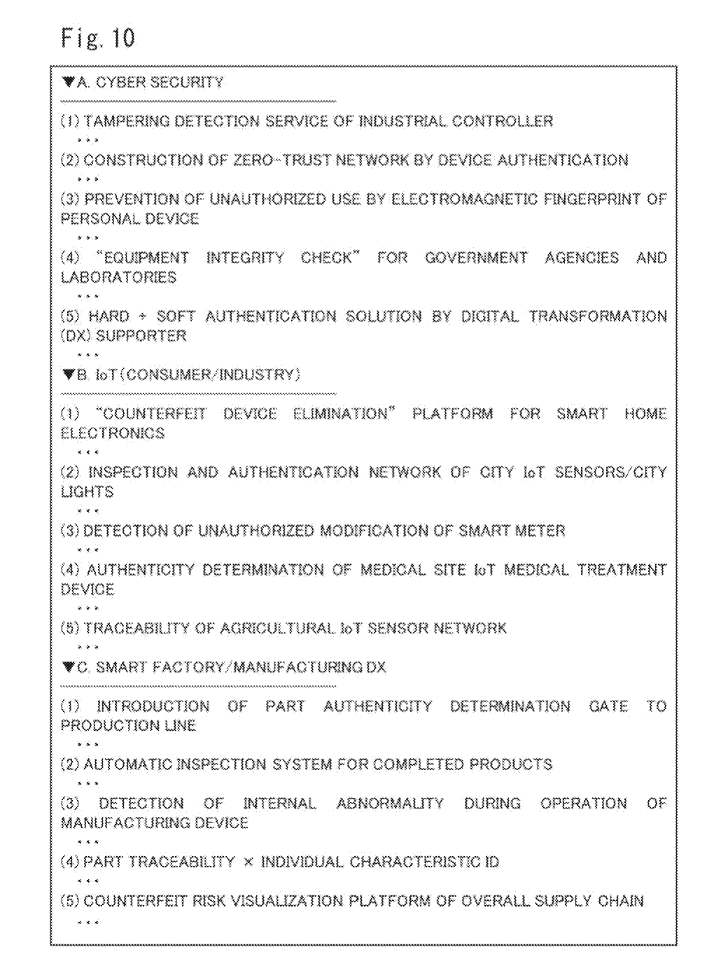

FIG. 10 illustrates an output example of the generative AI 122 with respect to the instruction P2 (selection of five business ideas and detailed explanation in each selected business category). In the example of FIG. 10, five business ideas are generated for each of the three selected business categories in accordance with the instruction P2, and the generated five business ideas and detailed explanation of each business idea are output. A business idea can be appropriately generated by generating a business idea from the business category in a state where the business category related to patent information is generated. By outputting the detailed explanation of the business idea, the business idea can be specifically grasped.

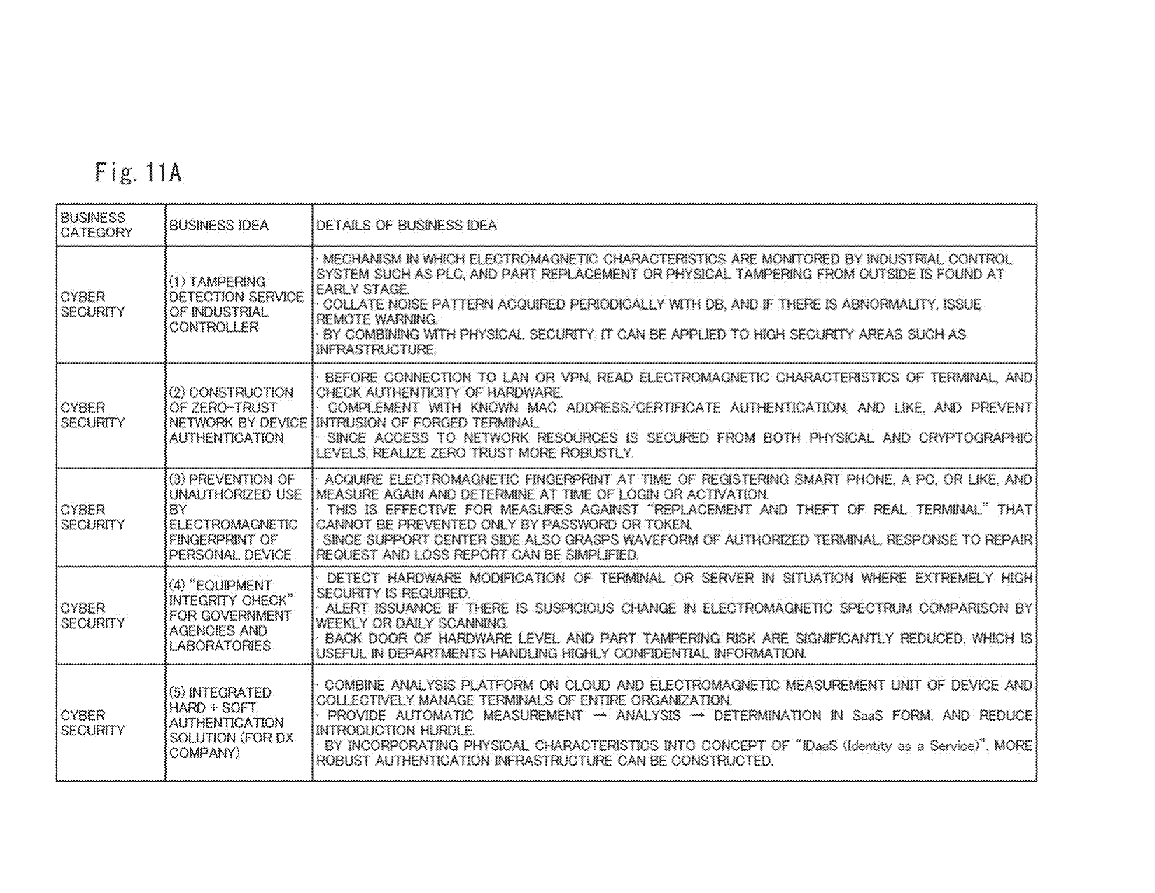

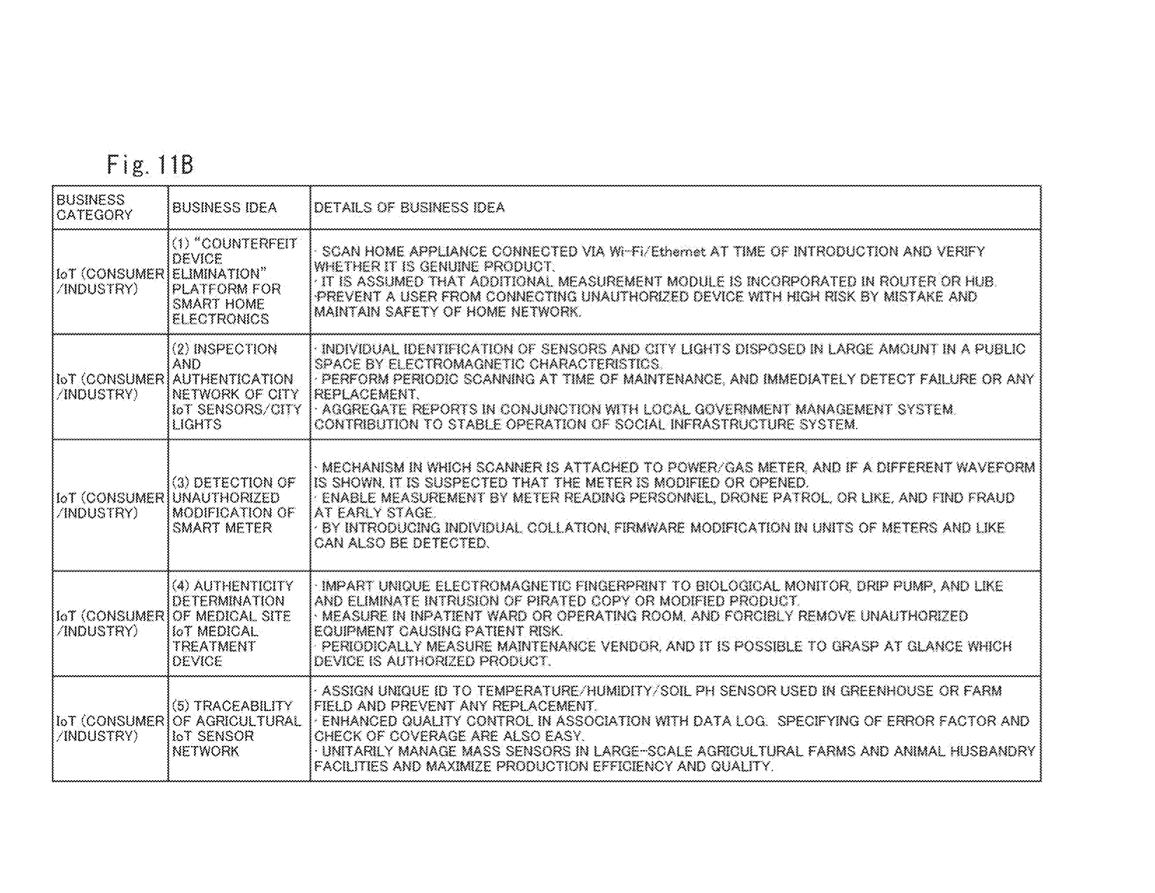

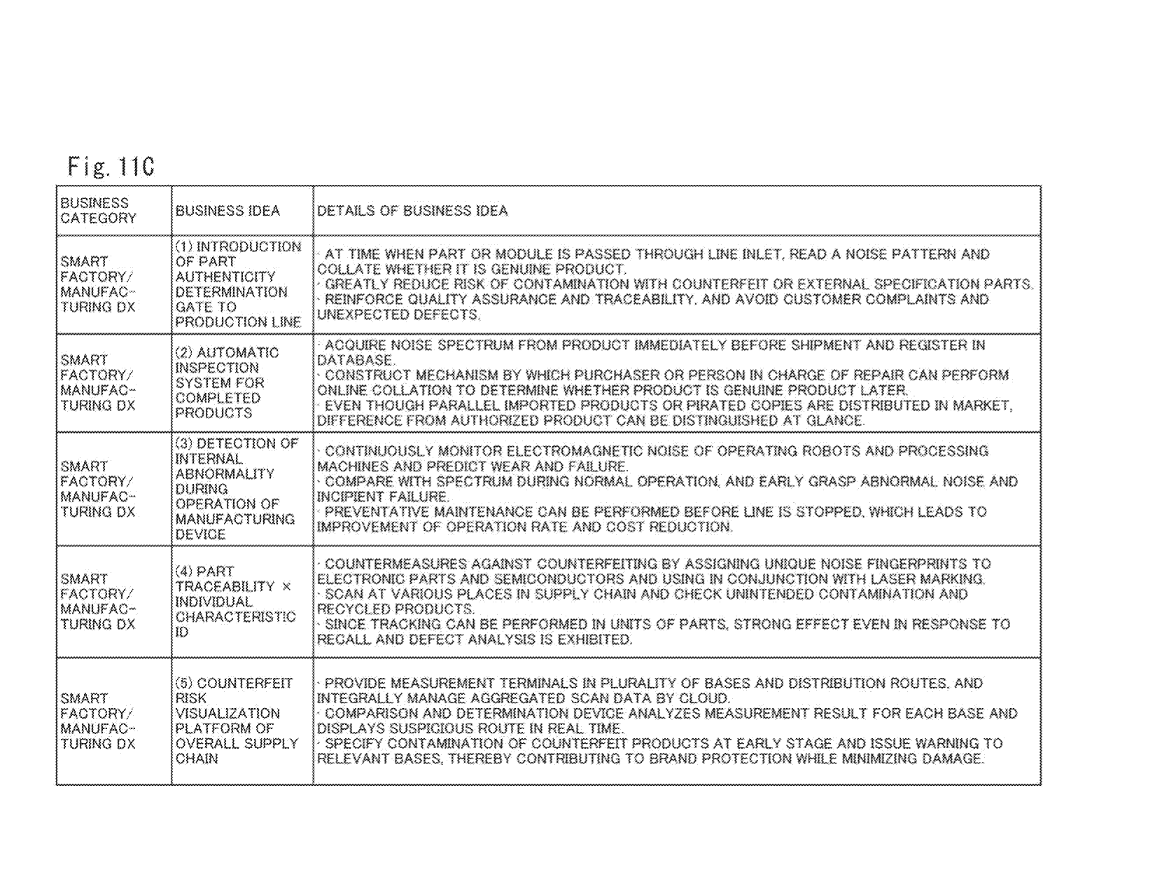

FIGS. 11A-11C illustrate output examples of the generative AI 122 in response to the instruction P3(the results of (P1) and (P2) are output in a table format with “business category”, “business idea”, and “details of business idea” as columns). In the example of FIGS. 11A-11C, the business category, the business idea, and the details of the business idea, which are illustrated in FIGS. 9 and 10, are output in a table format in accordance with the instruction P3.

Subsequently, the company search unit 130 searches the company database 320 for company information of a related company based on the generated business idea (S104). For example, the prompt input unit 131 inputs, to the generative AI 132, a prompt P20 for an instruction to search for company information related to the business idea from the company database 320.

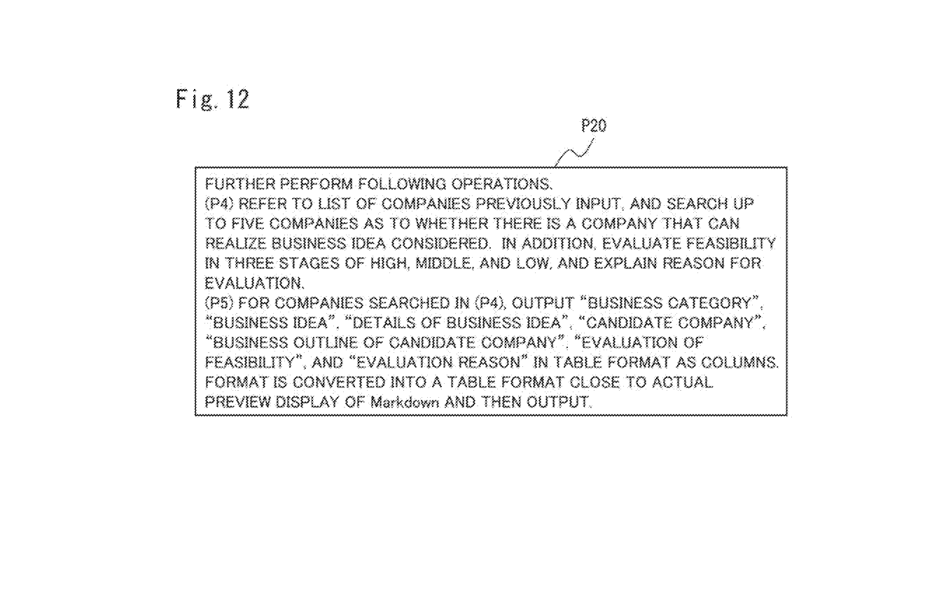

FIG. 12 illustrates an example of the prompt P20 to be input to the generative AI 132 according to some example embodiments. In the example of FIG. 12, the prompt P20 includes instructions P4 and P5. The instruction P4 is an instruction for searching the company database 320 for company information of a related company that can realize (be related to) the generated business idea, and evaluating a search result and generating an evaluation reason. As an example, in the instruction P4, it is instructed to search for five related companies. The instruction P5 is an instruction to output a result of the instruction P4 in a table format in which “business category”, “business idea”, “details of business idea”, “candidate company”, “business outline of candidate company”, “evaluation of feasibility”, and “evaluation reason” are set as columns. The number of companies to be searched for and the output format of the searched company may be set in advance or may be selected by the user. For example, output of some of “business category”, “business idea”, “details of business idea”, “candidate company”, “business outline of candidate company”, “evaluation of feasibility”, and “evaluation reason” may be omitted.

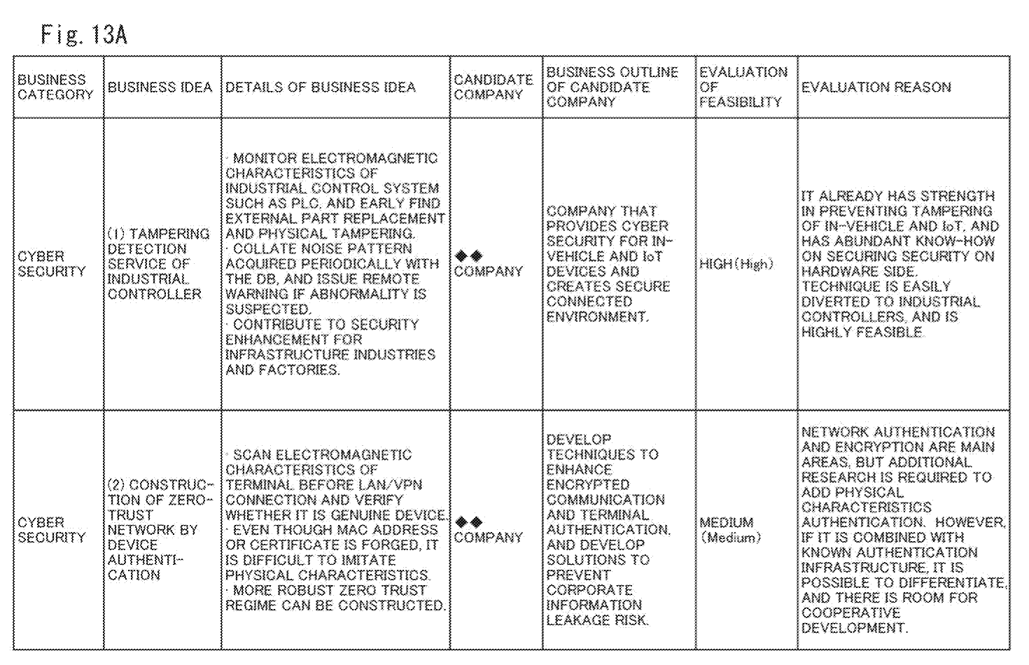

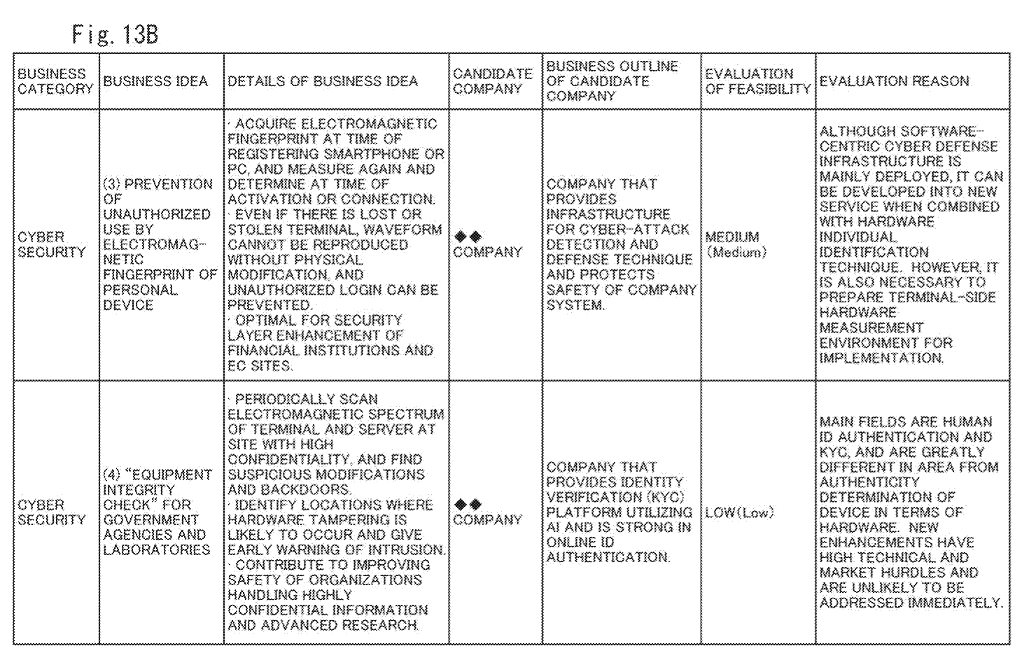

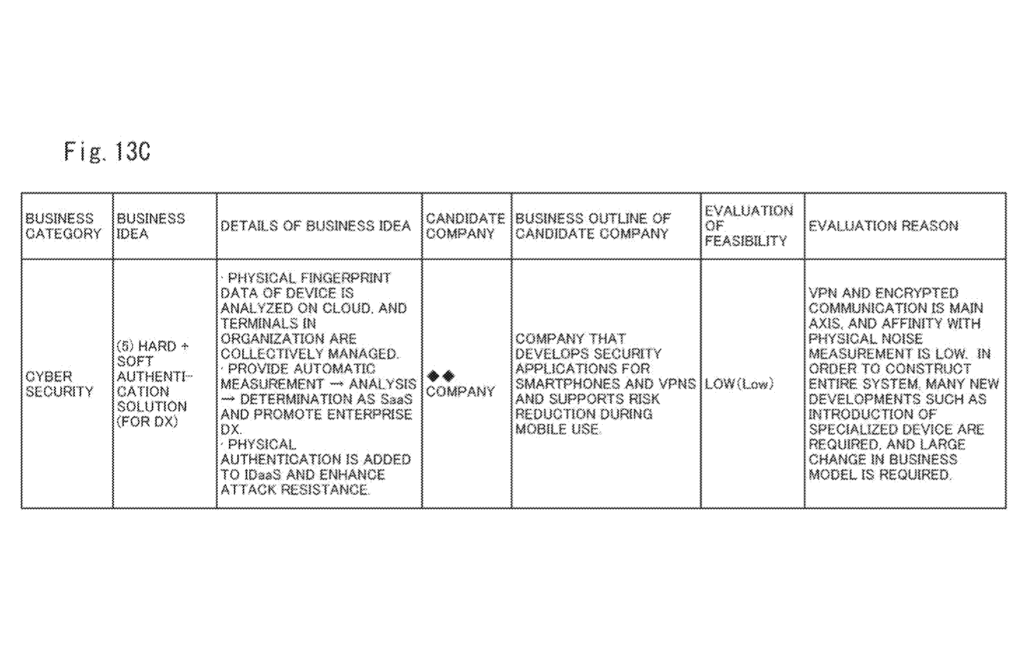

The generative AI 132 outputs results for the instructions P4 and P5 in accordance with the input prompt P20. FIGS. 13A-13C illustrate output examples of the generative AI 132 in response to the instructions P4 and P5. In the example of FIGS. 13A-13C, in accordance with the instructions P4 and P5, the company information of the searched related company, the evaluation of the search result, and the evaluation reason are output for each business idea in the generated business category. Specifically, the business category, the business idea, the details of the business idea, the candidate company (related company name), the business outline of the candidate company, the evaluation of the feasibility, and the evaluation reason are output in a table format. The business category, the business idea, and details of the business idea are similar to those in FIGS. 11A-11C. The candidate company and the business outline of the candidate company are information included in the searched company information. The evaluation of the feasibility and the reason for the evaluation are the results of analyzing the feasibility of the business idea based on the searched company information. By outputting the evaluation and the evaluation reason, it is possible to grasp the validity of the company extracted by the generative AI 132. For simplification, FIGS. 13A-13C illustrate only related companies related to business ideas included in one business category, but related companies related to business ideas included in the business category illustrated in each of FIGS. 11A-11C may be output.

Subsequently, the relevance degree calculation unit 140 calculates the relevance degree between the generated business idea and the searched company information (S105). The relevance degree calculation unit 140 calculates the relevance degree between the business idea and the business content in the company information for each searched company information. By outputting the calculated relevance degree, it is possible to clearly grasp the relation between the business idea and the company. For example, in a case where the evaluation of the feasibility is high and the relevance degree is high, there is a high possibility that the patent can be utilized in the business of the company. The relevance degree calculation unit 140 transmits the generated business idea, the searched company information, and the calculated relevance degree to the output unit 220. For example, the company information of which the evaluation of the feasibility is higher than a predetermined value and the relevance degree is higher than a predetermined value may be transmitted to the output unit 220. The relevance degree calculation unit 140 may transmit the acquired patent information to the output unit 220. The generated business idea may be transmitted from the business idea generation unit 120 to the output unit 220. The searched company information may be transmitted from the company search unit 130 to the output unit 220. The acquired patent information may be transmitted from the patent information acquisition unit 110 to the output unit 220.

Subsequently, the output unit 220 outputs the search result for the related company (S106). The output unit 220 displays the generated business idea, the searched company information, and the calculated relevance degree on the display screen. The output unit 220 may display only the business idea and the company information, or may further display the relevance degree. For example, a table of search results by the generative AI 132 illustrated in FIGS. 13A-13C may be included and displayed. The output unit 220 may display patent information.

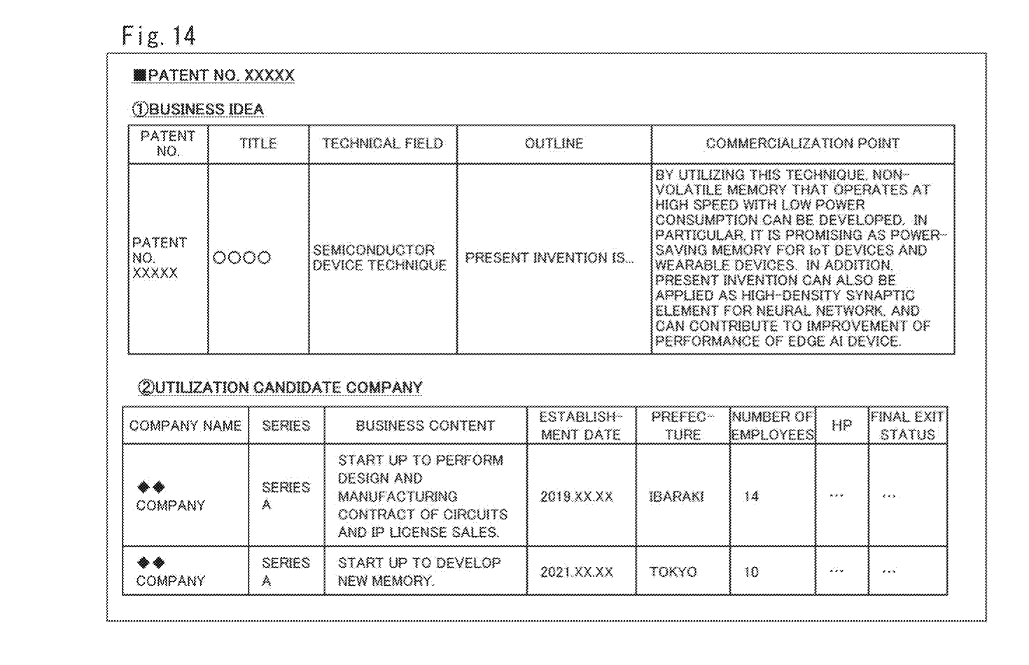

FIG. 14 illustrates an example of output of a search result for a related company. In the example of FIG. 14, a business idea and company information of each searched company (utilization candidate company) are output. As the business idea, a patent number, a title (name of the invention), a technical field, a summary (abstract), and a commercialization point (business idea) are output. Each piece of information included in the company database 320 illustrated in FIG. 6 is output as the company information.

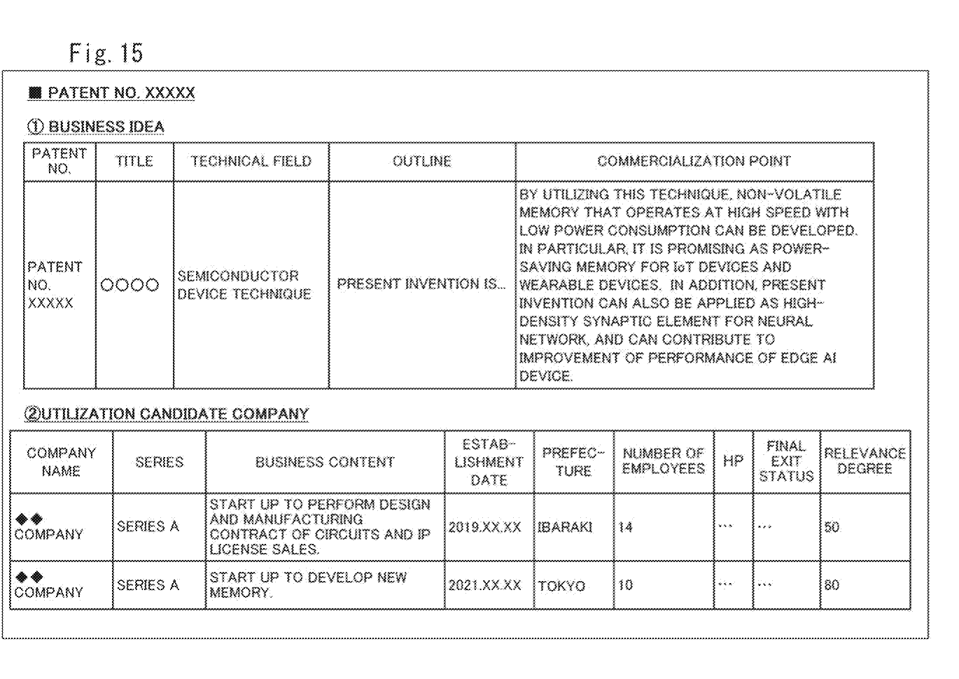

FIG. 15 illustrates another example of the output of the search result for the related company. In the example of FIG. 15, similarly to FIG. 14, the business idea and the company information of each searched company (utilization candidate company) are output, and the relevance degree for each piece of company information is further output. The company information having the relevance degree higher than the predetermined value may be highlighted, or only the company information having the relevance degree higher than the predetermined value may be displayed.

As described above, in the present example embodiment, the patent information is acquired from the patent database based on the patent identification number input from the user, and a plurality of business ideas are generated by using the generative AI. Then, the company database is searched based on these business ideas, and related companies are listed. Finally, the relevance degree between each company and the business idea is scored, and the result is output. As a result, matching work between patent information and company information is automated, and significant efficiency can be achieved. By generating a business idea by the generative AI, it is possible to propose a new utilization method that has not been conceived by humans. By exhaustively searching for utilization destinations of techniques, it is possible to achieve co-creation by a license of the own technique.

### Third Example Embodiment

Next, a third example embodiment will be described. In the present example embodiment, an example of generating a business model constructed by a searched related company as in the second example embodiment will be described.

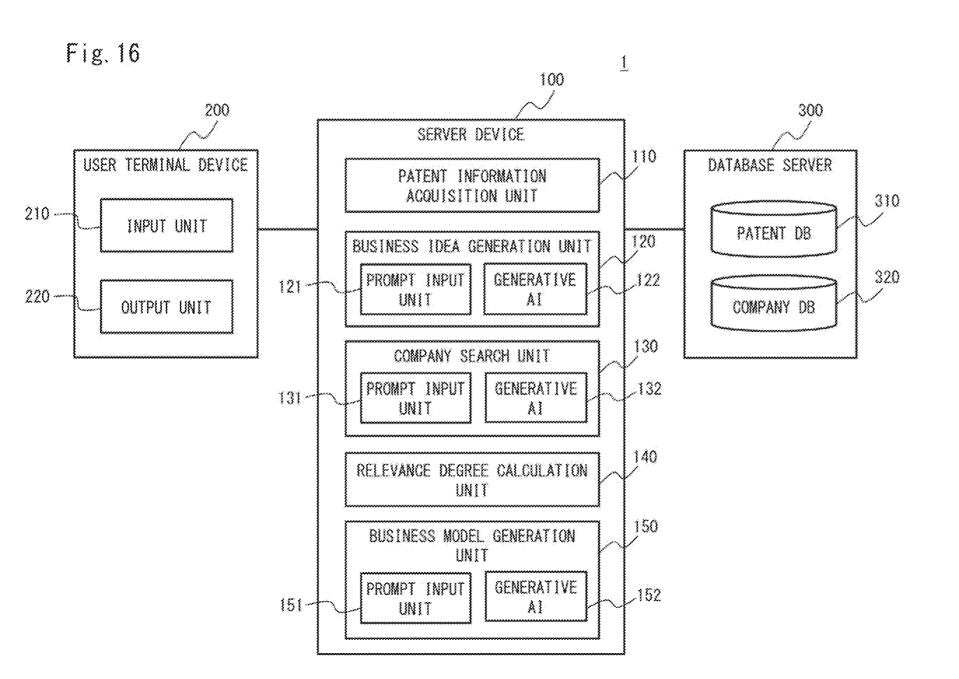

FIG. 16 illustrates a configuration example of a search system 1 according to some example embodiments. In the example of FIG. 16, in contrast to the configuration example of FIG. 4, the server device 100 further includes a business model generation unit 150. The rest is similar to those in FIG. 4. The business model generation unit 150 may be the same block as the company search unit 130.

The business model generation unit 150 generates a business model constructed by a related company. The business model generation unit 150 generates an optimal business model constructed by the related company based on the company information of the related company searched by the company search unit 130. The business model is a business model constructed by the related company in order to realize the generated business idea.

The business model generation unit 150 includes a prompt input unit 151 and generative AI 152. The prompt input unit 151 inputs a prompt (for example, a third prompt) including an instruction to generate a business model from the company information of the searched related company, to the generative AI 152 (for example, third generative AI). For example, the prompt to be input to the generative AI 152 may be set in advance, or the user may input information necessary for the prompt. The generative AI 152 generates a business model from the company information of the searched related company in accordance with the input prompt. The generative AI 152 is an LLM similarly to the generative AIs 122 and 132. The generative AI 152 may be an LLM that has learned general-purpose data or may be an LLM that has been fine-tuned in such a way as to generate an appropriate business model from the company information.

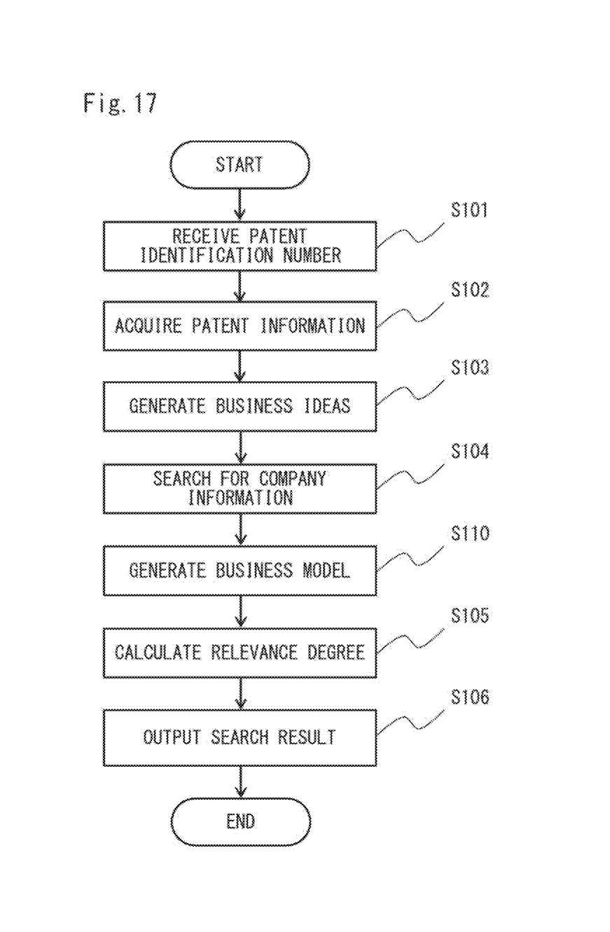

FIG. 17 illustrates an operation example of the search system 1 according to some example embodiments. In the example of FIG. 17, a business model generation process (S110) is added to the operation example of FIG. 7. Others are similar to those illustrated in FIG. 7.

Specifically, after the company information of the related company is searched for in S104, the business model generation unit 150 generates an optimal business model constructed by the related company based on the searched company information of the related company (S110). For example, the prompt input unit 151 inputs a prompt P30 for an instruction to generate a business model from the searched company information of the related company, to the generative AI 152.

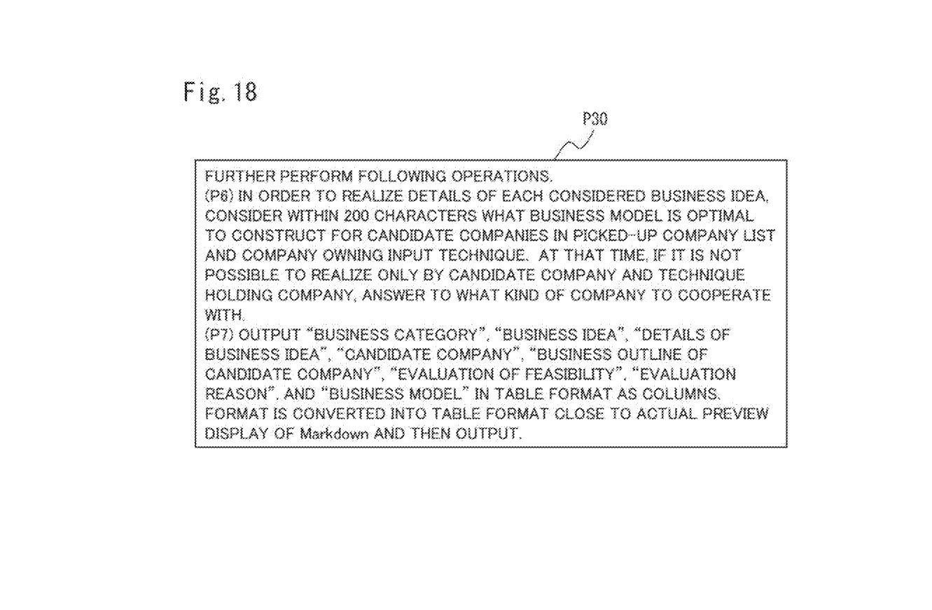

FIG. 18 illustrates an example of the prompt P30 to be input to the generative AI 152 according to some example embodiments. In the example of FIG. 18, the prompt P30 includes instructions P6 and P7. The instruction P6 is an instruction for generating a business model (based on company information) constructed by the searched company in order to realize the generated business idea. In the instruction P6, in a case where the business idea cannot be realized by a single company, it is instructed to generate a cooperating company. The instruction P7 is an instruction to output a result of the instruction P6 in a table format in which “business category”, “business idea”, “details of business idea”, “candidate company”, “business outline of candidate company”, “evaluation of feasibility”, “evaluation reason”, and “business model” are set as columns. The output format of the generated business model may be set in advance or may be selected by the user. For example, output of some of “business category”, “business idea”, “details of business idea”, “candidate company”, “business outline of candidate company”, “evaluation of feasibility”, and “evaluation reason” may be omitted.

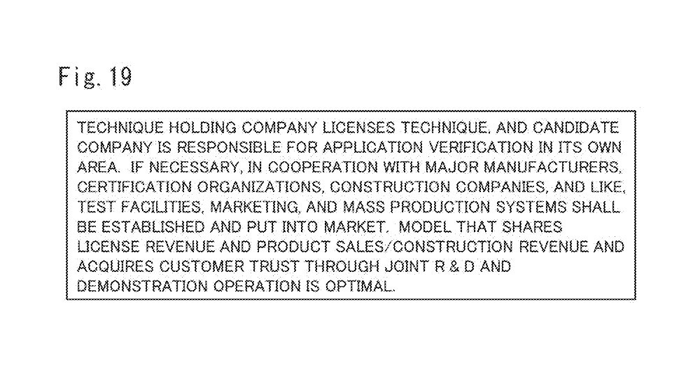

The generative AI 152 outputs results for the instructions P6 and P7 in accordance with the input prompt. FIG. 19 illustrates an output example of the generative AI 152 in response to the instruction P6 (consideration of the business model). In the example of FIG. 19, in accordance with the instruction P6, the business model constructed by the related company and the company that cooperates to realize the business model (business idea) are output. By outputting a cooperating company, it is possible to increase the feasibility in a case where the business model cannot be realized by a single company. Although one business model is illustrated, the business model may be output for each company.

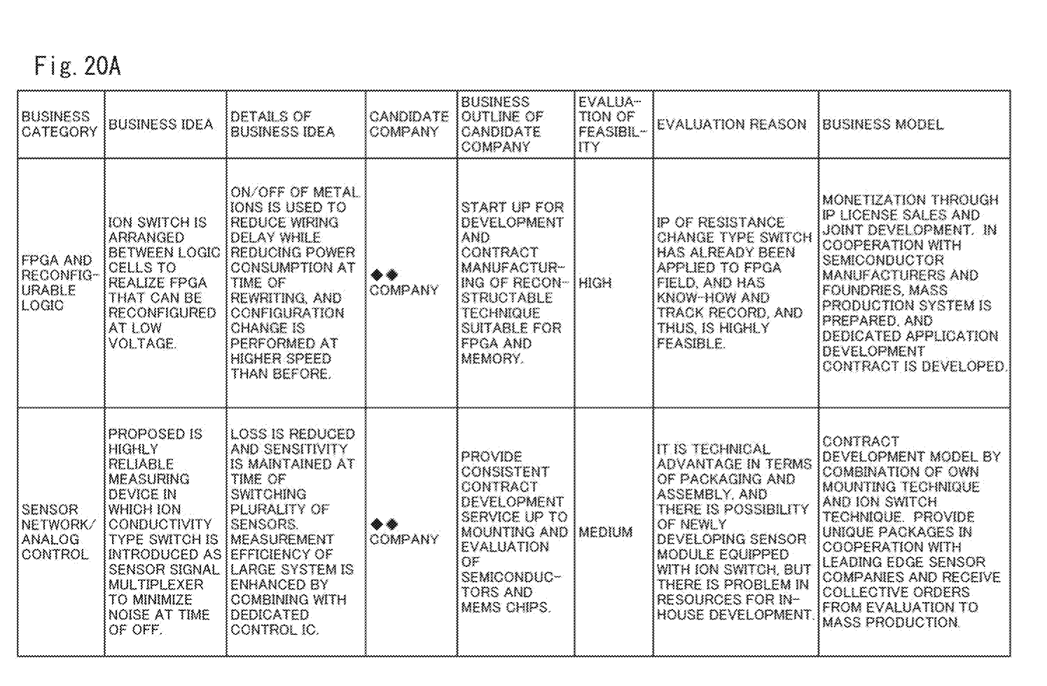

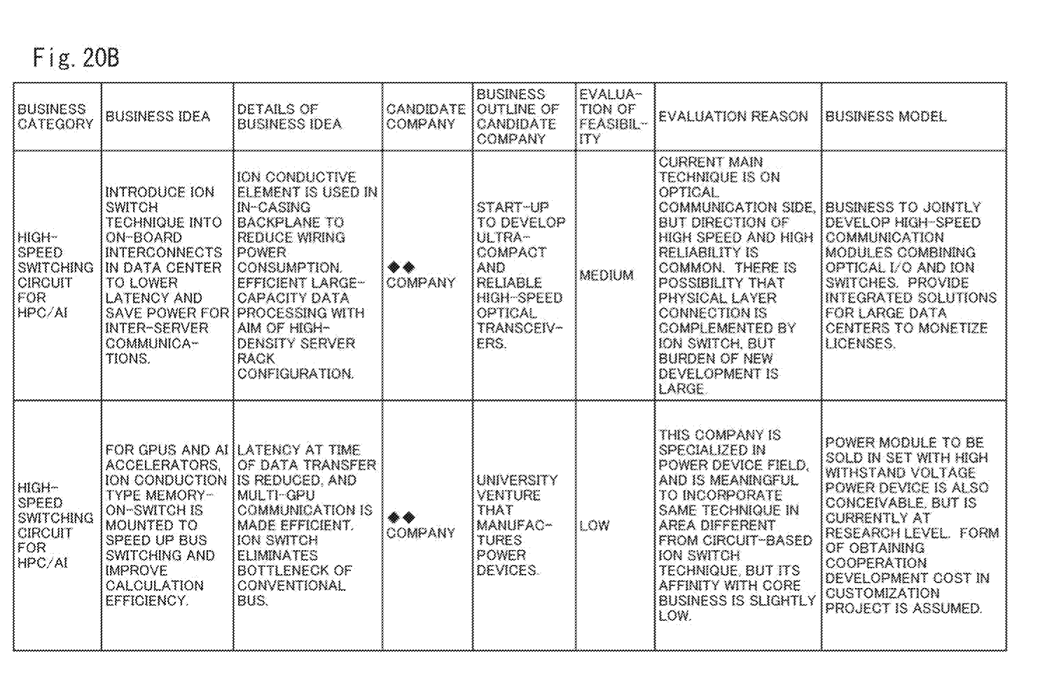

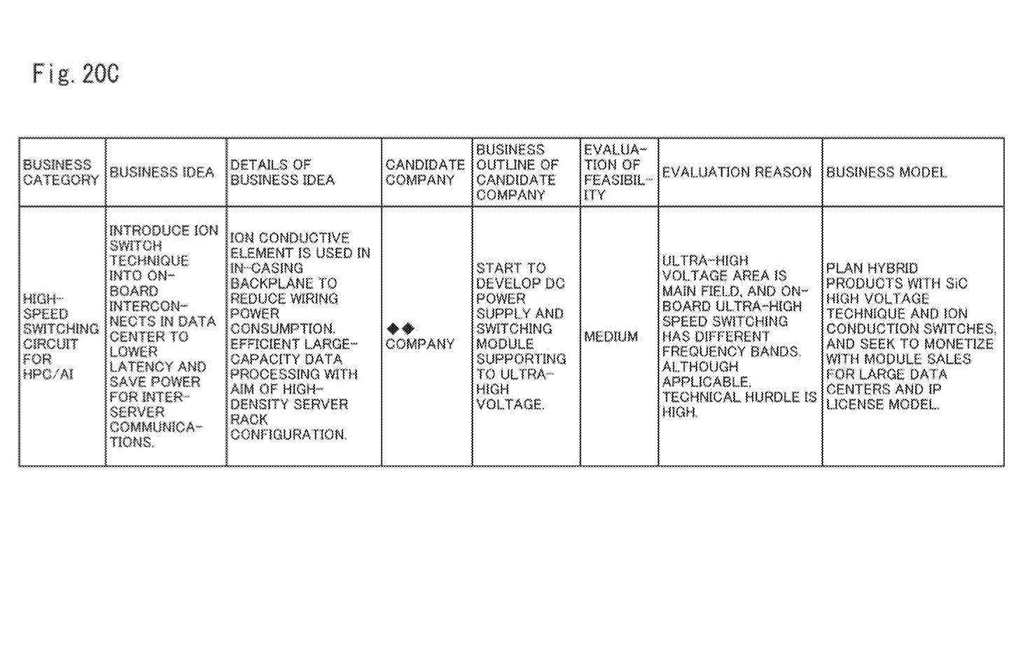

FIGS. 20A-20C illustrate output examples of the generative AI 152 in response to the instruction P7. The example of FIGS. 20A-20C outputs the business model for each searched related company in accordance with the instruction P7 (output in a table format with “business category”, “business idea”, “details of business idea”, “candidate company”, “business outline of candidate company”, “evaluation of feasibility”, “evaluation reason”, and “business model” as columns). Specifically, the business category, the business idea, the details of the business idea, the candidate company, the business outline of the candidate company, the evaluation of the feasibility, and the evaluation reason, and the business model are output in a table format. The business category, the business idea, the details of the business idea, the candidate company, the business outline of the candidate company, the evaluation of the feasibility, and the evaluation reason are similar to those in FIGS. 13A-13C. The business model to be output is a business model generated based on the searched company information for each business idea and company. As in FIG. 19, the business model includes a company as a cooperation destination. For example, the company as the cooperation destination may be a company that compensates for the technique determined to be insufficient for the evaluation reason. The company information of the cooperation destination may be searched from the company database 320, and the searched company information of the cooperation destination may be further output.

Subsequently, the relevance degree calculation unit 140 calculates the relevance degree between the generated business idea and the searched company information (S105). For example, the relevance degree calculation unit 140 may calculate the relevance degree between the company information and the business idea including the business model. Subsequently, the output unit 220 outputs a search result of the related company including the business model (S106). For example, the output unit 220 may display a table of generation results of the generative AI 152 including the business models illustrated in FIGS. 20A-20C as the searched company information.

As described above, in a case where a business idea is generated from patent information and a related company related to the business idea is searched for, a business model constructed by the searched related company may be generated. As a result, it is possible to output an optimal business model to be constructed for realizing the business idea and perform matching including the business model.

### Fourth Example Embodiment

Next, a fourth example embodiment will be described. In the present example embodiment, an example of searching for a related company by using other types of company information at time of searching for the related company as in the second example embodiment will be described. The present example embodiment may be applied to the third example embodiment.

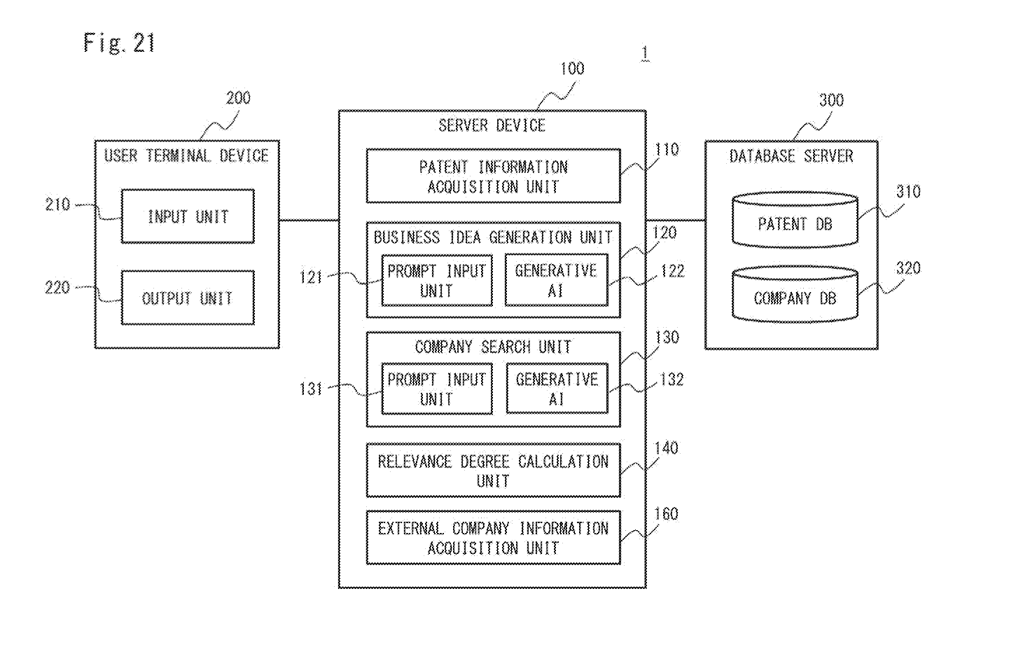

FIG. 21 illustrates a configuration example of a search system 1 according to some example embodiments. In the example of FIG. 21, in contrast to the configuration example of FIG. 4, the server device 100 further includes an external company information acquisition unit 160. The rest is similar to those in FIG. 4.

The external company information acquisition unit 160 acquires other types of company information than the information stored in the company database 320 from the outside. For example, the information may be acquired from an external database, or information disclosed on a homepage or the like of a company on the Internet may be acquired. For example, the other type of company information is a management index including financial information and a growth rate of a company. For example, the external company information acquisition unit 160 may refer to a homepage of a company, and acquire a management index such as a sales growth rate, a profit rate, and a research and development cost ratio of the company for the last three years.

The company search unit 130 searches for a company related to the business idea based on the company information in the company database 320 and other types of company information acquired from the outside. For example, the prompt input unit 131 instructs the generative AI 132 to search for a company related to the business idea with reference to the company information in the company database 320 and other types of company information acquired from the outside. The generative AI 132 searches for a company related to the business idea from the company database 320, and extracts a company having the highest management index or higher than a predetermined value from among the searched companies.

As described above, a company may be searched in consideration of a management index including financial information and a growth rate of the company. As a result, it is possible to preferentially extract not only a technical capability but also a company having a high possibility of commercialization, and it is possible to search for a more appropriate cooperation destination.

### Fifth Example Embodiment

Next, a fifth example embodiment will be described. In the present example embodiment, an example in which a related company is searched by using university/research institution information in a university/research institution database at time of searching for a related company as in the second example embodiment will be described. The present example embodiment may be applied to the third or fourth example embodiment.

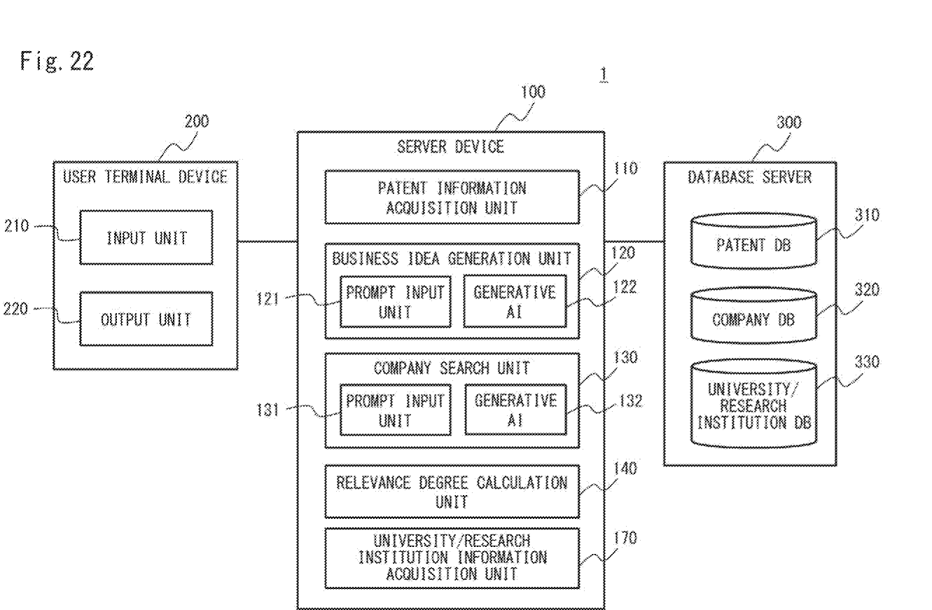

FIG. 22 illustrates a configuration example of a search system 1 according to some example embodiments. In the example of FIG. 22, in contrast to the configuration example of FIG. 4, the database server 300 includes a university/research institution database (DB) 330. The server device 100 includes a university/research institution information acquisition unit 170. The rest is similar to those in FIG. 4.

The university/research institution database 330 is a database that stores university/research institution information. For example, the university/research institution information is patent information owned by the university/research institution. The university/research institution information is not limited to the patent information, and information such as a paper indicating research contents may be used. The university/research institution may include either or both of the university and the research institution.

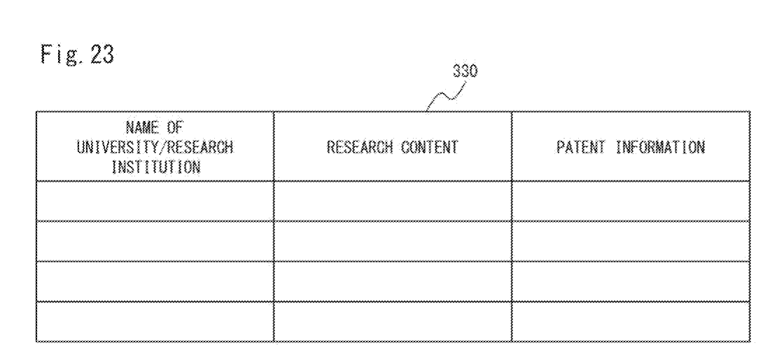

FIG. 23 is a diagram illustrating an example of data of the university/research institution database 330 according to some example embodiments. In the example of FIG. 23, the university/research institution database 330 stores the name of the university/research institution, the research content, and the patent information for each university/research institution. The patent information stored in the university/research institution database 330 may be information similar to that of the patent database 310.

The university/research institution information acquisition unit 170 searches and acquires university/research institution information. For example, the university/research institution information acquisition unit 170 searches the university/research institution database 330 for university/research institution information related to the patent information based on the patent information acquired by the patent information acquisition unit 110. The university/research institution information acquisition unit 170 may search for university/research institution information including research contents related to the business idea based on the business idea generated by the business idea generation unit 120.

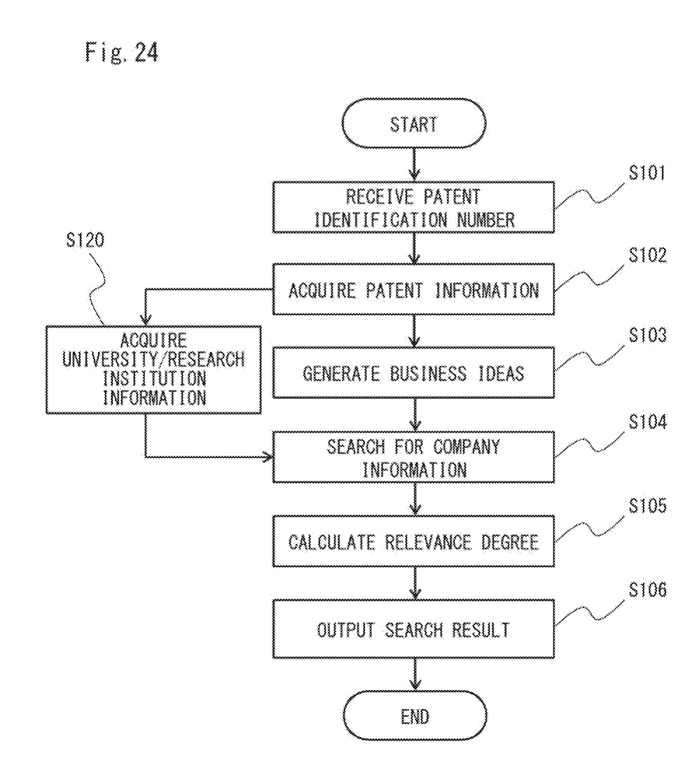

FIG. 24 illustrates an operation example of the search system 1 according to some example embodiments. In the example of FIG. 24, a university/research institution information acquisition process (S120) is added to the operation example of FIG. 7. Others are similar to those illustrated in FIG. 7.

Specifically, after the patent information is acquired in S102, the university/research institution information acquisition unit 170 acquires the university/research institution information related to the patent information from the university/research institution database 330 based on the acquired patent information. For example, a search is performed for a university or a research institution having patent information (high relevance degree) related to the acquired patent information.

Subsequently, the company search unit 130 searches the company database 320 for company information based on the generated business idea and the acquired university/and research institution information (S104). For example, the company search unit 130 searches for a company related to the business idea, and extracts a company that can cooperate with a university/research institution from among the searched companies. For example, university/research institution information including research contents (high relevance degree) related to the business contents of the company information may be extracted.

Subsequently, the relevance degree between the generated business idea and the searched company information, and the relevance degree between the company information and the university/research institution information are calculated (S105). For example, the relevance degree between the business idea and the business content of the company information, and the relevance degree between the business content of the company information and the research content of the university/research institution information may be calculated. The relevance degree calculation unit 140 may perform scoring in consideration of technical affinity between the company and the university/research institution, past collaboration results between industry and academia, and the like.

Subsequently, the output unit 220 outputs the search result for the related company (S106). For example, the output unit 220 displays the generated business idea, the searched company information and university/research institution information, and the calculated relevance degree on the display screen. The output unit 220 may display the matching result between the company and the university/research institution together with the respective features and strengths, and support the user to select the optimal cooperation destination.

As described above, a company may be searched for by using patent information or the like of a university/research institution. For example, a company that can cooperate with a university/research institution may be searched for by using information of the university or the research institution related to the input patent information. For example, for a business idea related to “biofuel”, university laboratories that are conducting related research and companies that can utilize the technique may be searched at the same time, and the possibility of cooperation between industry and academia may be presented. As a result, it is possible to further search for an appropriate cooperation destination. By performing search including the patent information of universities and research institutions, it is possible to match the latest technique seeds with the needs of companies, and it is possible to greatly increase opportunities for industry/academia cooperation and technology transfer.

The present disclosure is not limited to the above-described example embodiments, and can be appropriately modified without departing from the scope.

For example, the above example embodiments relate to a system that efficiently searches for related companies and techniques by using patent information and business ideas as inputs, and relates to software. The present system may execute processing such as analysis of patent information and business ideas, company search, and relevance degree calculation at a high speed by using a dedicated hardware accelerator. Specifically, the following configuration may be adopted.
Field Programmable Gate Array (FPGA) for patent information analysis: A dedicated FPGA for performing the natural language processing of the patent description or claims at a high speed may be mounted. This FPGA quickly processes a large amount of patent information by performing parallel processing of text analysis and feature extraction.
AI dedicated chip for business idea generation: A dedicated chip for efficiently executing the generative AI model may be mounted. This chip enables high-speed inference processing with low power consumption, and generates various business ideas in a short time.
High speed cache memory for company database search: Large-capacity high-speed cache memory that stores frequently accessed company information may be implemented. As a result, the response time of the company search is significantly reduced.
Parallel processing unit for relevance degree calculation: A dedicated processing unit that calculates the relevance degree between a company and a business idea in parallel may be implemented. This unit simultaneously calculates a plurality of evaluation indexes and performs scoring at a high speed.
Real-time data update mechanism: A dedicated hardware mechanism may be implemented that updates the information in the patent database and the company database in real time. As a result, analysis and search based on the latest information at all times can be performed.
By combining these dedicated hardware components, the present system functions as a special machine rather than simply executing software, and achieves high-speed processing and highly accurate search that are difficult to be achieved with a related general-purpose computer.

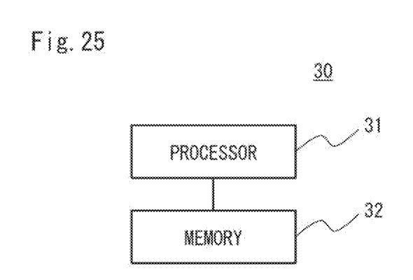

Each configuration in the above-described example embodiments may be implemented by hardware, software, or both, and may be implemented by one piece of hardware or software or by a plurality of pieces of hardware or software. Each device including the server device, the user terminal device, and the like and each function (processing) may be implemented by a computer 30 including a processor 31 such as a central processing unit (CPU) and a memory 32 that is a storage device as illustrated in FIG. 25. For example, a program for performing the method (search method) in the example embodiments may be stored in the memory 32, and each function may be implemented by executing the program stored in the memory 32 by the processor 31.

These programs include a group of commands (or software codes) causing a computer to perform one or more of the functions described in the example embodiments in a case of being read by the computer. The program may be stored in a non-transitory computer readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technique, a CD-ROM, a digital versatile disc (DVD), a Blu-ray (registered trademark) disc or any other optical disc storage, and a magnetic cassette, a magnetic tape, a magnetic disk storage, or any other magnetic storage device. The program may be transmitted through a transitory computer-readable medium or a communication medium. As an example and not by way of limitation, the transitory computer-readable medium or the communication medium includes electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings is merely illustrative to describe one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings to describe illustrative example embodiments are not necessarily mandatory, and some features or steps may be omitted. The order of the steps described in any of the drawings may be appropriately changed.

Some or all of the above example embodiments may also be described as the following Supplementary Notes, but are not limited to the following Supplementary Notes.

### Supplementary Note 1

A search device including:
acquisition means for acquiring patent information;
generation means for generating a business idea related to the patent information based on the acquired patent information; search means for searching, based on the generated business idea, for company information related to a business idea from a company database that stores company information including a business content of a company; and
output means for outputting the generated business idea and the searched company information.

### Supplementary Note 2

The search device according to Supplementary Note 1, in which the generation means inputs a first prompt for an instruction to output a business idea related to the patent information to first generative AI, and generates the business idea by the first generative AI.

### Supplementary Note 3

The search device according to Supplementary Note 2, in which the first prompt includes an instruction to select a business category related to the patent information and output a business idea in the selected business category.

### Supplementary Note 4

The search device according to Supplementary Note 1, in which the generation means generates the business idea by using a learning model obtained by performing machine learning of a relation between the patent information and the business idea.

### Supplementary Note 5

The search device according to Supplementary Note 1, in which the search means inputs a second prompt for an instruction to output company information related to the business idea from the company database to second generative AI capable of retrieval augmented generation, and searches for the company information by the second generative AI.

### Supplementary Note 6

The search device according to Supplementary Note 5, in which the second prompt includes an instruction to output the searched company information, an evaluation of the searched company information, and a reason for the evaluation.

### Supplementary Note 7

The search device according to Supplementary Note 1, in which the search means searches for company information related to the business idea based on a relevance degree between the business idea and a business content of the company information.

### Supplementary Note 8

The search device according to Supplementary Note 1, in which the search means generates a business model constructed by a company of the searched company information.

### Supplementary Note 9

The search device according to Supplementary Note 8, in which the search means inputs a third prompt for an instruction to output a business model constructed by a company of the searched company information based on the business idea to third generative AI, and generates the business model by the third generative AI.

### Supplementary Note 10

The search device according to Supplementary Note 1, in which
the company information includes a management index of a company, and
the search means searches for company information related to the business idea based on the management index of the company.

### Supplementary Note 11

The search device according to Supplementary Note 1, in which the search means searches for university or research institution information related to the patent information or the business idea from a university or research institution database that stores university or research institution information including a research content of the university or research institution.

### Supplementary Note 12

The search device according to Supplementary Note 1, in which the output means outputs a relevance degree between the generated business idea and a business content of the searched company information.

### Supplementary Note 13

A search system including:
a company database that stores company information including a business content of a company;
acquisition means for acquiring patent information;
generation means for generating a business idea related to the patent information based on the acquired patent information;
search means for searching for company information related to a business idea from a company database, based on the generated business idea; and
output means for outputting the generated business idea and the searched company information.

### Supplementary Note 14

A search method performed by a search device, the search method including:
acquiring patent information;
generating a business idea related to the patent information based on the acquired patent information;
searching, based on the generated business idea, for company information related to the business idea from a company database that stores company information including a business content of a company; and
outputting the generated business idea and the searched company information.

### Supplementary Note 15

A program for causing a computer to execute processing including:
acquiring patent information; generating a business idea related to the patent information based on the acquired patent information;
searching, based on the generated business idea, for company information related to the business idea from a company database that stores company information including a business content of a company; and
outputting the generated business idea and the searched company information.

Some or all of the elements (for example, configurations and functions) described in Supplementary Notes 2 to 12 dependent on Supplementary Note 1 (search device) can also be dependent on Supplementary Note 13 (search system), Supplementary Note 14 (search method), and Supplementary Note 15 (program) by the same dependency relationship as Supplementary Notes 2 to 12. Some or all of the elements described in any Supplementary Note can be applied to various types of hardware, software, recording means for recording software, systems, and methods.

What is claimed is:

1. A search device comprising:
a memory configured to store instructions; and
a processor configured to execute the instructions to:
acquire patent information;
generate a business idea related to the patent information based on the acquired patent information;
search, based on the generated business idea, for company information related to the business idea from a company database that stores company information including a business content of a company; and
output the generated business idea and the searched company information.

2. The search device according to claim 1, wherein the processor is further configured to execute the instructions to: input a first prompt for an instruction to output the business idea related to the patent information to first generative AI, and generate the business idea by the first generative AI.

3. The search device according to claim 2, wherein the first prompt includes an instruction to select a business category related to the patent information and output a business idea in the selected business category.

4. The search device according to claim 1, wherein the processor is further configured to execute the instructions to: generate the business idea by using a learning model obtained by performing machine learning of a relation between the patent information and the business idea.

5. The search device according to claim 1, wherein the processor is further configured to execute the instructions to: input a second prompt for an instruction to output the company information related to the business idea from the company database to second generative AI capable of retrieval augmented generation, and search for the company information by the second generative AI.

6. The search device according to claim 5, wherein the second prompt includes an instruction to output the searched company information, an evaluation of the searched company information, and a reason for the evaluation.

7. The search device according to claim 1, wherein the processor is further configured to execute the instructions to: search for the company information related to the business idea based on a relevance degree between the business idea and a business content of the company information.

8. The search device according to claim 1, wherein the processor is further configured to execute the instructions to: generate a business model constructed by a company of the searched company information.

9. The search device according to claim 8, wherein the processor is further configured to execute the instructions to: input a third prompt for an instruction to output the business model constructed by the company of the searched company information based on the business idea to third generative AI, and generate the business model by the third generative AI.

10. The search device according to claim 1, wherein
the company information includes a management index of a company, and
the processor is further configured to execute the instructions to:
search for the company information related to the business idea based on the management index of the company.

11. The search device according to claim 1, wherein the processor is further configured to execute the instructions to: search for university or research institution information related to the patent information or the business idea from a university or research institution database that stores university or research institution information including research contents of a university or research institution.

12. The search device according to claim 1, wherein the processor is further configured to execute the instructions to: output a relevance degree between the generated business idea and a business content of the searched company information.

13. A search system comprising:
a company database that stores company information including a business content of a company;
a memory configured to store instructions; and
a processor configured to execute the instructions to:
acquire patent information;
generate a business idea related to the patent information based on the acquired patent information;
search for company information related to the business idea from the company database based on the generated business idea; and
output the generated business idea and the searched company information.

14. A search method performed by a search device, the search method comprising:
acquiring patent information;
generating a business idea related to the patent information based on the acquired patent information;
searching, based on the generated business idea, for company information related to the business idea from a company database that stores company information including a business content of a company; and
outputting the generated business idea and the searched company information.
